(19) United States
(12) Patent Application Publication
(10) Pub. No.: US 2008/0072988 A1
(43) Pub. Date: Mar. 27, 2008

(54) Glass Syntactic Polyurethane Insulated Product

(75) Inventors: Fati Elgendy, Lincolnshire, IL (US); John Carusisello, Lemont, IL (US); William Harris, Highland Park, IL (US)

Correspondence Address: SCHWARTZ COOPER CHARTERED;IP DEPARTMENT, 180 NORTH LASALLE STREET, SUITE 2700, CHICAGO, IL, 60601, US

(73) Assignee: PERMA-PIPE, INC., Niles, IL (US)

(21) Appl. No.: 11/843,320

(22) Filed: Aug. 22, 2007

Related U.S. Application Data
(60) Provisional application No. 60/839,207, filed on Aug. 22, 2006.

(51) Int. Cl. F16L 9/14

(52) U.S. Cl. 138/149; 138/146

(57) ABSTRACT

A pipe (1) or other fluid conduit is disclosed having an outer surface (14) with an anticorrosive coating (16) applied thereon. An insulation system comprising a glass syntactic polyurethane (GSPU) layer (10), a laminate layer (20), preferably comprising an aluminum foil (22) disposed and bonded between two sheets of polyethylene (PE) (21), and a jacket (30) of high density polyethylene (HDPE) are placed about the pipe (1) or fluid conduit to insulate and protect the pipe (1) or other fluid conduit.

### CROSS-REFERENCE TO RELATED APPLICATIONS

This application claims priority to currently pending U.S. Provisional Patent Application No. 60/839,207 filed Aug. 22, 2006, which is hereby incorporated by reference as if fully set forth herein.

### TECHNICAL FIELD

The present invention relates to insulation, and in particular, GSPU insulation having a water and vapor barrier.

### BACKGROUND OF THE INVENTION

Oil and gas exploration and development companies have improved both their exploration techniques and their production techniques to tap deep-water oil and gas reserves, such as in oceans, bays and gulfs. This effort has prompted the need for insulation systems for fluid conduits (i.e., pipes), called flow assurance lines (horizontal flowlines and vertical steel catenary risers), which meet thermal insulation (U-value) requirements in colder temperatures at great depths and increased hydrostatic pressures. The insulation systems keep the fluids from developing solid hydrate formations and waxy buildup which can reduce or block flow and which in turn are costly and disruptive to clear. The more effective the insulation, the longer the oil and gas companies have to clear buildups and blockages. “Pipe-in-Pipe” insulation systems in which a strong steel outer casing pipe is used to protect the insulation from deep water pressure have been used, and will continue to be used, to meet these purposes and needs.

However, newer insulation technology has been developed to create a “wet” insulation system that can be directly applied to a pipe or flowline and does not require a protective casing pipe.

It has been learned that as the pipe and insulation become hot when subjected to deep water hydrostatic pressure, the insulation will absorb water over time on its outer exposed surfaces. This absorption of water degrades the insulation and reduces the insulation properties of the insulation where the water has penetrated. Typically extra insulation thickness is employed to compensate for the reduction of insulation effectiveness due to the water absorption.

### SUMMARY OF THE INVENTION

The present invention is directed to a multilayer insulation system that employs water penetration and vapor barriers around an insulation layer or barrier. The use of water penetration and vapor barriers prevents water from contacting the insulation resulting in a better performing insulation product.

One aspect of the present invention provides an insulated pipe. The insulated pipe comprises a tubular fluid conduit having an outer surface and an inner surface defining a passageway for transporting a fluid pressure. The tubular fluid conduit may include an anti-corrosive coating applied to the outer surface. An insulation barrier is positioned about the tubular fluid conduit. A first fluid barrier is positioned about the insulation barrier and may be capable of preventing liquid and/or vapor from contacting the insulation barrier.

The insulation barrier may be a glass syntactic polyurethane bonded to the tubular fluid conduit.

The first fluid barrier may be wrapped circumferentially about the insulation barrier. Alternatively, the fluid barrier may be wrapped spirally about the insulation barrier or used as a slip sheet and seamed. Further, the first fluid barrier may have a laminate structure. The laminate structure may comprise an inner layer and an outer layer, each layer may be produced from a polymeric material. A center layer may be disposed between the inner and outer layers and produced from a metallic foil. The center layer may be bonded to the inner and/or outer layer.

The insulated pipe may further have a second fluid barrier about the first fluid barrier. The second fluid barrier may be produced from an extruded high density polyethylene.

Another aspect of the present invention is directed to a method of reducing the thickness of an insulation layer bonded about a fluid conduit while obtaining the same insulating properties as in present existing systems having a greater amount of identical type insulation. The method includes providing a tubular fluid conduit having an inner surface and an outer surface and providing a first layer of a glass syntactic polyurethane insulation material. The first layer is bonded about the outer surface of the tubular fluid conduit. A laminate vapor barrier is provide about the insulation material. The laminate vapor barrier comprises inner and outer layers of a polyethylene bonded to a center layer of a metallic foil disposed therebetween. The laminate layer is bonded to a radially outer surface of the first layer. A fluid barrier is also provided and bonded to a radially outer surface of the laminate vapor barrier.

### BRIEF DESCRIPTION OF THE DRAWINGS

FIG. 1 is side plan view of a product made in accordance with the teachings of the present invention;

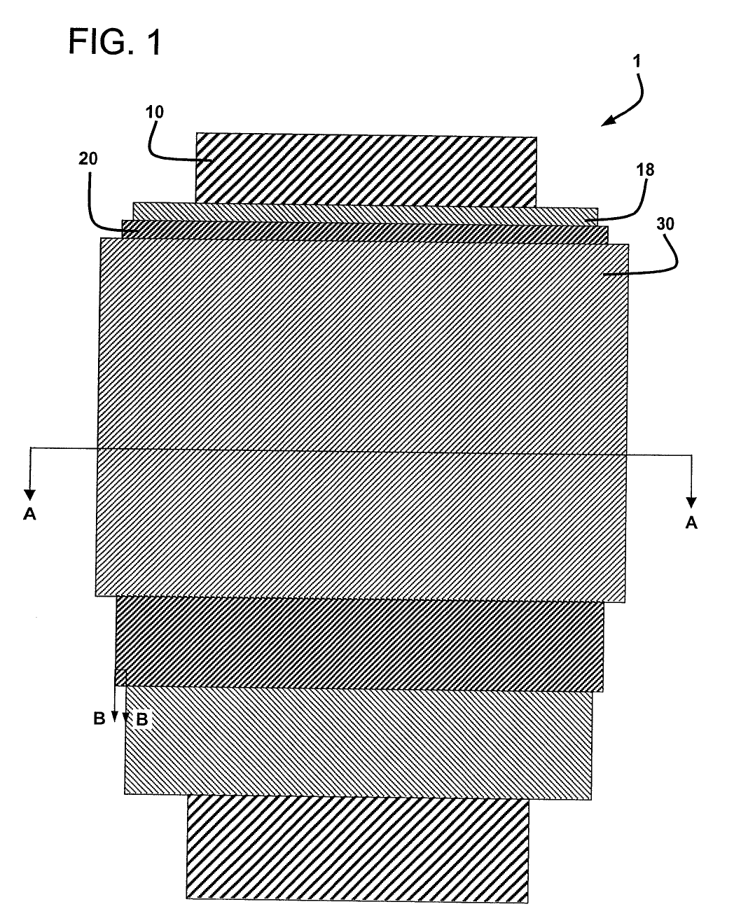

FIG. 1A is a sectional view taken along A-A of the product of FIG. 1; and

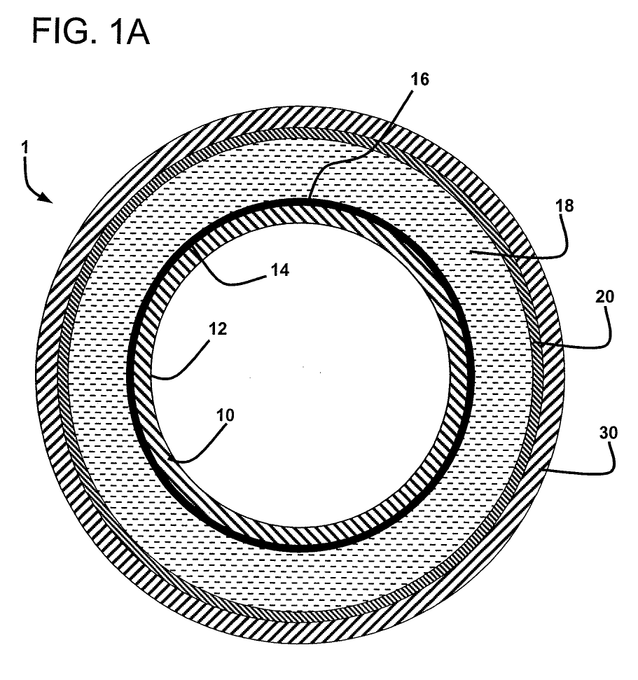

FIG. 1B is a highly magnified sectional view taken along B-B of the product of FIG. 1.

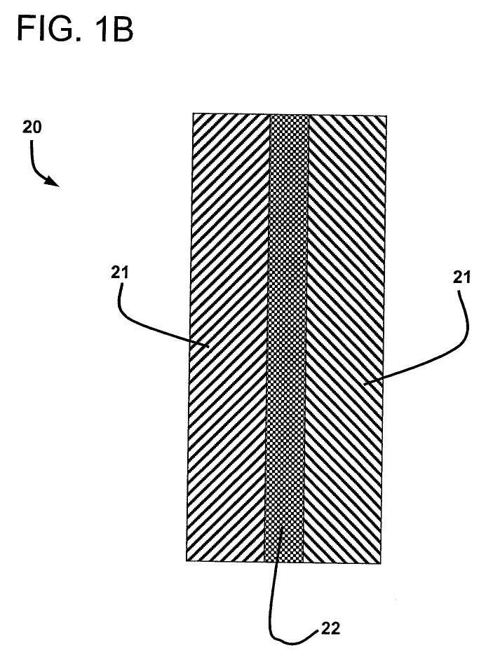

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is directed to a multilayer insulation system that employs water penetration and vapor barriers around the insulation. The use of fluid barriers capable of withstanding liquid and/or vapor penetration, e.g. water, from contacting and degrading the insulation resulting in a better performing insulation product. As a result, due to the introduction of the barriers, one can reduce the thickness of the insulation around the pipe (at significant cost savings) to obtain the same insulating properties as in present existing systems without a vapor barrier.

In addition to using the present insulation around pipes carrying hot fluids in underground and undersea applications, the present product can be used in cryogenics applications, such as conduits carrying liquids (argon, nitrogen, helium, hydrogen and oxygen) and other liquefied gases having extremely low temperatures (−60/C to −266/C).

Note that while the discussion herein centers around pipes, it is recognized that other conduit components, such as joints, elbows, tees, laterals, couplers, etc. can be insulated in the manners discussed herein.

The Pipe 1

Typically, the pipe 1 includes a fluid conduit 10, preferably a tubular metal pipe produced from a steel. The fluid conduit 10 (e.g., pipes) has a nominal diameter of between 4 inches and 24 inches and comprise an inner surface 12 and an outer conduit surface 14 with an anticorrosive coating 16 thereon and one or more insulation layers disposed on the anticorrosive coating surface. The inner surface defines a passageway for transferring a fluid pressure. Adjacent the pipe are the following layers:

The First Layer 10—GSPU

The insulation is a glass syntactic polyurethane (GSPU) 18. The method of molding the GSPU is disclosed in another patent application, U.S. patent application for “Method and System for Cast Molding a Fluid Conduit,” U.S. application Ser. No. 11/137,626, filed May 25, 2005, naming Robert Appleby, Glen Pfanner and Billy Ervin as inventors (Attorney Docket No. 3636 P 091). This application and the disclosure therein is incorporated by reference. The insulation is molded to a substantially uniform radial thickness and cured to form a cast molded conduit. Preferably, the insulation has a thickness of between 0.75 to 4 inches. This molding may occur in either a static or a progressive mold. During the molding process, while curing, or post-curing, the second layer, discussed in the next section, can be applied and bonded to the outer surface of GSPU.

The Second Layer 20—A Laminate

The second layer 20 acts as a fluid, preferably having liquid and/or vapor barrier characteristics, and is a laminate comprising a sheet of aluminum foil disposed and bonded between two sheets of polyethylene (PE). (sheet of foil 22 between two sheets of polyethylene 21). The laminate is obtained from Curwood Inc. (Oshkosh, WI), A Bemis company, and others.

The laminate 20 can be wrapped circumferentially or spirally about the GSPU 10 or used as a slip sheet and seamed (See U.S. application Ser. No. 11/137,626).

As an alternative, instead of the laminate being applied (extruded, wrapped or as a slip sheet) to the outer surface of the GSPU, one can apply a thin polyethylene or high density polyethylene (HDPE) layer. The polyethylene or HDPE alone will act as a moisture barrier. However, the laminate with aluminum foil will act as a better moisture barrier.

The Third Layer 30—A High Density Polyethylene Jacket

After the curing process and barrier application, a high density polyethylene coating (HDPE) 30 is extruded around the insulated conduit. This layer 30 protects the inner fluid barrier layer 20, bonds to it and is itself an effective fluid barrier to water in both liquid and vapor form. Thus two layers 20,30 of fluid barrier protection are provided. Additional properties may be added to the HDPE protective layer such as rough coat, a technique for assuring a high coefficient of friction that is useful for handling the insulated and jacketed pipe. The ends of the HDPE layer 30 may be cut off at the ends or the layer carried over the ends of the GSPU and sealed to the pipe 1 and its anticorrosive coating 3.

Other System Features—Field Joints

For the insulation system to be effective, it must also provide for the continuity of the fluid barriers 20,30, both laminate 20 and HDPE 30, and HDPE protective layers across the joints where pipe segments are welded together. Field joints are provided for this purpose comprising a layer of molded GSPU, bonded to the pipe and its anticorrosive coating and spanning from the GSPU insulation of one pipe segment to the next segment. Around the field joint GSPU is wrapped a tight laminate sheet which is sealed on itself and the GSPU. A final casing sleeve or wrap of HDPE is then fitted over the field joint and shrunk into tight contact with the GSPU and laminate fluid barrier underneath. Thus, a continuous uninterrupted vapor barrier and protective jacket is created.

Other System Features—Bonding

Each layer from the steel pipe up to the outermost HDPE protective jacket must be bonded to each adjacent layer. Handling and deployment of the insulated system requires gripping the system and restraining it when necessary. Any slippage between layers results in loss of restraint and control, and possibly wrinkling and damage to the system. Continuous bonding is a unique and valuable feature of the described system.

We claim:

1. An insulated pipe comprising:
a tubular fluid conduit having an outer surface and an inner surface defining a passageway for transporting a fluid pressure therethrough;
an insulation barrier about the tubular fluid conduit; and
a first fluid barrier about the insulation barrier capable of preventing a fluid from degrading the insulation barrier.

2. The insulated pipe of claim 1 wherein the insulation barrier is bonded to the tubular fluid conduit.

3. The insulated pipe of claim 2 wherein the first fluid barrier has a laminate structure.

4. The insulated pipe of claim 3 wherein the laminate structure comprises an inner layer and an outer layer.

5. The insulated pipe of claim 4 wherein the inner layer and the outer layer are produced from a polymeric material.

6. The insulated pipe of claim 5 wherein a center layer disposed between the inner and outer layers is produced from a metallic foil.

7. The insulated pipe of claim 6 wherein the center layer is bonded to the inner layer.

8. The insulated pipe of claim 6 wherein the center layer is bonded to the outer layer.

9. The insulated pipe of claim 6 wherein the center layer is bonded to the inner layer and the outer layer.

10. The insulated pipe of claim 9 wherein the first fluid barrier is wrapped circumferentially about the insulation barrier.

11. The insulated pipe of claim 9 wherein the first fluid barrier is wrapped spirally about the insulation barrier.

12. The insulated pip of claim 9 wherein the first fluid barrier is used as a slip sheet and seamed.

13. The insulated pipe of claim 3 further comprising a second fluid barrier about the first vapor barrier.

14. The insulated pipe of claim 13 wherein the second fluid barrier is produced from a high density polyethylene.

15. The insulated pipe of claim 14 wherein the high density polyethylene is extruded about the first vapor barrier.

16. The insulated pipe of claim 15 wherein the tubular fluid conduit includes an anti-corrosive coating applied to the outer surface.

17. The insulated pipe of claim 1 further comprising a second fluid barrier about the first vapor barrier.

18. The insulated pipe of claim 1 wherein the insulation barrier is a glass syntactic polyurethane.

19. An insulated pipe comprising:
a tubular member having an outer surface with an anti-corrosive coating and an inner surface defining a passageway for transporting a fluid pressure therethrough;
an insulation barrier bonded about the tubular member comprising a glass syntactic polyurethane having a uniform radial thickness between 0.75 inches and 4 inches;
a first vapor barrier bonded to a radially outer surface of the insulation barrier and having a laminate structure of an inner layer and an outer layer of a polyethylene and a center layer of an aluminum foil disposed therebetween and bonded thereto; and
a second vapor barrier of a high density polyethylene bonded about the first vapor barrier.

20. A method of reducing the thickness of an insulation layer bonded about a fluid conduit while obtaining the same insulating properties as in present existing systems, the method comprising the steps of:
providing a tubular fluid conduit having an inner surface and an outer surface;
providing a first layer of a glass syntactic polyurethane insulation material;
bonding the first layer about the outer surface of the tubular fluid conduit;
providing a laminate vapor barrier about the insulation material comprising inner and outer layers of a polyethylene bonded to center layer of a metallic foil disposed therebetween;
bonding the laminate layer to a radially outer surface of the first layer;
providing a fluid barrier; and
bonding the fluid barrier to a radially outer surface of the laminate vapor barrier.
